(19) United States
(12) Patent Application Publication
(10) Pub. No.: US 2006/0127687 A1
(43) Pub. Date: Jun. 15, 2006

(54) Method for producing aramid laminate

(76) Inventors: Takanari Yamaguchi, Tsukuba-shi, Ibaraki (JP); Hiroaki Kumada, Inashiki-gun (JP)

Correspondence Address: BIRCH STEWART KOLASCH & BIRCH, PO BOX 747, FALLS CHURCH, VA, 22040-0747, US

(21) Appl. No.: 10/539,074

(22) PCT Filed: Dec. 17, 2003
(86) PCT No.: PCT/JP03/16142

§ 371 Date: Jun. 15, 2005

(30) Foreign Application Priority Data
Dec. 25, 2002 (JP) 2002-374034

(51) Int. Cl. B32B 27/34

(52) U.S. Cl. 428/474.4; 156/307.3; 156/307.7

(57) ABSTRACT

A process for preparing an aramid laminate, which comprises impregnating a surface and an interior an aramid paper with a liquid crystal polymer, and laminating a layer comprising an aramid paper and a layer comprising a liquid crystal polymer.

### TECHNICAL FIELD

The present invention relates to an aramid laminate used insulator such as in a motor, transformer, or electric•electronic circuit substrates such as printed circuit board.

### BACKGROUND TECHNIQUE

Since an aramid paper is excellent in heat resistance, it is widely used in utility such as insulator, and substrates such as printed circuit boards and, for example, as an insulating material using an aramid paper, an aramid laminate in which an aramid paper and a polyethylene terephthalate (hereinafter referred to as “PET”) film are laminated and integrated is proposed (JP-A No. 7-32549).

However, when the aramid laminate is exposed to a high temperature by a step of solder reflow and the like, deformation such as warpage occurs in the aramid laminate in some cases since PET itself is inferior in solder heat resistance.

In addition, as a substrate of a printed curcuit board using an aramid paper, an aramid laminate in which an aramid paper and a thermosetting resin are combined is proposed (JP-A No. 2000-141522).

However, since a thermosetting resin has a large moisture absorption rate, electric reliability of electronic parts packaged on the printed circuit board is decreased due to operating environment such as a temperature and a humidity in some cases.

On the other hand, as an example on a heat resistant material other than an aramid paper used in utility of a substrate, a laminate using a heat resistant liquid crystal polymer film as a substrate of a printed circuit board is proposed (JP-A No. 08-323923).

However, since a liquid crystal polymer has anisotropy, and an expansion rate of a printed circuit board is different every direction of the circuit board due to anisotropy of a liquid crystal polymer, in the field requiring a further finer circuit wiring, procession of a circuit wiring becomes further difficult, and it may be difficult to suppress breakage of a circuit wiring due to thermal expansion of the circuit board in some cases.

An object of the present invention is to provide a process for preparing an aramid laminate excellent in solder heat resistance and low hygroscopicity.

### DISCLOSURE OF THE INVENTION

In order to solve the aforementioned problems, the present inventors intensively studied and, as a result, found out that, by laminating each at least one layer of a layer composed of an aramid paper and a layer composed of a liquid crystal polymer, an aramid laminate excellent in solder heat resistance and low hygroscopicity is obtained, which resulted in completion of the present invention.

That is, the present invention relates to:

a process for preparing an aramid laminate which comprises a step of laminating a layer comprising an aramid paper and a layer comprising a liquid crystal polymer by impregnating a surface and an interior of an aramid paper with a liquid crystal polymer, and penetrating the liquid crystal polymer into the aramid paper, or

a process for preparing an aramid laminate which comprises a step of thermally fusing a layer comprising an aramid paper and a layer comprising a liquid crystal polymer at a temperature range of from a temperature lower than a flowing temperature of a liquid crystal polymer by 30° C. to lower than 400° C. at a planar pressure of 10 kg/cm² or higher, or at a linear pressure of 20 kg/cm or higher, and relates to a circuit substrate comprising the aramid laminate obtained by the process any of the aforementioned processes.

### PREFERABLE MODE FOR CARRYING OUT THE INVENTION

The present invention will be explained below.

An aramid paper used in the present invention will be explained.

The aramid paper of the present invention is a heat resistant paper composed of an aramid fibrid, an armid short fiber and the like, and is generally prepared by a process of making a paper by a wet format from these aramid fibrid, aramid short fiber and the like. The “fibrid” is a coined word by DuPont and means a fine fibrous material having papermaking property.

An aramid paper is generally a paper of a fibrid or a short fiber composed of wholly aromatic aramid such as p-aramid and m-aramid alone, or a paper of an appropriate combination of them.

Herein, p-aramid is an alternate copolymer of an aromatic diamine, as represented by 1,4-diaminobenzene and 4,4′-diaminodiphenyl ether in which two amino groups in a molecule substitute at para positions of a benzene ring with each other, and aromatic dicarboxylic acids, as represented by terephthalatic acid in which two carboxyl groups in a molecule substitute at para positions of a benzene ring with each other, and has an amide bond structure in which an amino group and a carboxyl group are mutually condensed. Example of such the p-aramid include poly(p-phenyleneterephthalamide), and poly(p-diphenyletherterephthalamide). In addition, m-aramid has the same molecular structure except that a binding relation of the p-aramid in changed from a para position to a meta position, and examples include poly(m-phenyleneisophthalamide).

A process for preparing an aramid fibrid is not limited, but specifically, an aramid fibrid can be obtained by wet precipitation of a solution containing aramid, for example, a sulfuric acid solution, and an organic solution such as NMP. In addition, a process for preparing an aramid paper is not particularly limited, but examples include a method of dispersing the fibrid or the aramid short fiber in an aqueous solution to the diluted slurry state of around 0.01 to 1.0% by weight, converting this to a web with a paper making machine and, thereafter, obtaining an aramid paper via a water squeezing step and a drying step. When this aramid paper is made, if necessary, a fiber or a pulp of other heat resistance resin may be blended. Specifically, for example, a fiber or a pulp of a liquid crystal polymer containing a wholly aromatic polyester, or super engineering plastics such as aromatic polyether ether ketone (PEEK) may be blended. In addition, if necessary, by subjecting an aramid paper to calendaring procession, necessary mechanical property may be imparted to an aramid paper, or a thickness or a density thereof may be adjusted.

A layer composed of a liquid crystal polymer can be laminated on a layer composed of an aramid paper by the aforementioned method and a process for preparing an aramid laminate such as provision of a layer composed of a liquid crystal polymer on a metal layer can be performed by the same method as the aforementioned method.

Upon preparation of an aramid laminate, an aramid laminate may be prepared by a stepwise process of laminating one layer by one layer, or an aramid laminate may be prepared by a process of laminating respective layers at once by a method of thermal pressing or thermal roll.

A liquid crystal polymer used in the present invention is a polymer exhibiting optical anisotropy at melting, which is called thermotropic liquid crystal polymer. Examples of such the liquid crystal polymer include wholly aromatic polyester containing no aliphatic carbon on a polymer chain, liquid crystal polyesters such as aromatic polyester containing an aliphatic carbon on a polymer chain, liquid crystal imides such as polyester imide, liquid crystal amides such as polyester amides, and resin compositions containing them. Preferable are liquid crystal polyesters and resin compositions containing them, and further preferable are wholly aromatic liquid crystal polyester and resin compositions containing it.

Specific examples of a liquid crystal polymer as represented by liquid crystal polyester include:

1) A liquid crystal polymer composed of a combination of a repeating unit derived from aromatic dicarboxylic acid, a repeating unit derived from aromatic diol, and a repeating unit derived from aromatic hydroxycarboxylic acid,

2) A liquid crystal polymer composed of a combination of repeating units derived from different aromatic hydroxycarboxylic acids,

3) A liquid crystal polymer composed of a combination of a repeating unit derived from aromatic dicarboxylic acid and a repeating unit derived from aromatic diol, and

4) A liquid crystal polymer obtained by reacting polyester such as polyethylene terephthalate with aromatic hydroxycarboxylic acid.

These usually form an anisotropic molten state at a temperature of 400° C. or lower. It is preferable that liquid crystal polyester composed of each combination of the 1) to 3) is wholly aromatic liquid crystal polyester. In addition, in place of aromatic dicarboxylic acid, aromatic diol and aromatic hydroxycarboxylic acid used in preparation of the liquid crystal polyester, an ester forming derivative thereof may be used. Further, instead of these aromatic dicarboxylic acid, aromatic diol and aromatic hydroxylcarboxylic acid, a compound in which an aromatic nucleus is substituted with a halogen atom, an alkyl group, or an aryl group. Examples of a repeating unit include the following units.

(I) The following repeating unit derived from aromatic dicarboxylic acid:

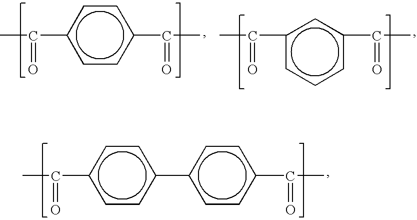

A hydrogen atom of a benzene ring in each structure may be substiuted with a halogen atom, an alkyl group, or an aryl group.

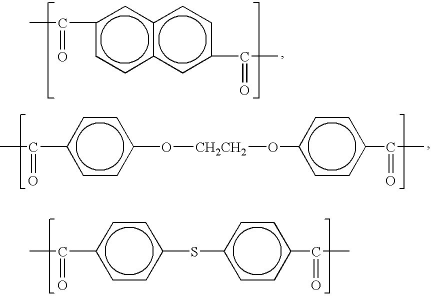

A hydrogen atom of a benzene ring in each structure may be substiuted with a halogen atom, an alkyl group, or an aryl group.

II) The following repeating unit derived from aromatic diol:

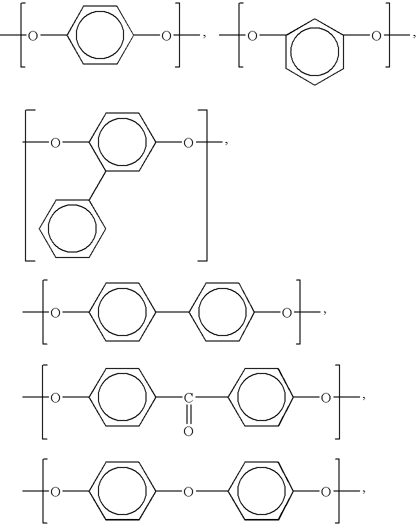

A hydrogen atom of a benzene ring in each structure may be substituted with a halogen atom, an alkyl group, or an aryl group.

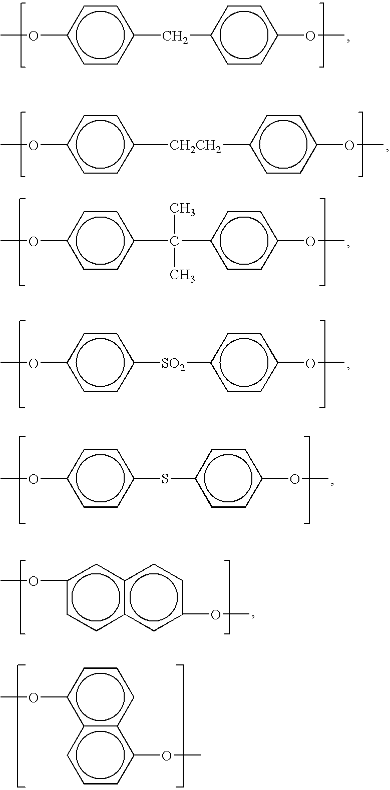

A hydrogen atom of a benzene ring in each structure may be substituted with a halogen atom, an alky; group, or an aryl group.

III) The following repeating unit derived from aromatic hydroxycarboxylic acid:

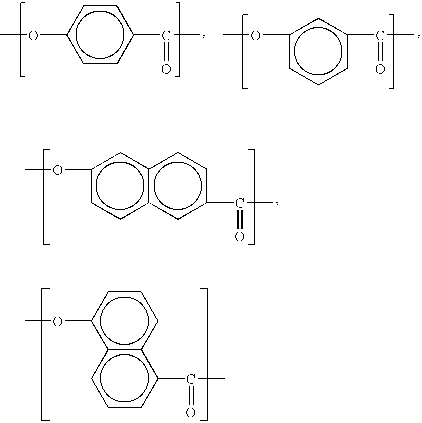

A hydrogen atom of a benzene ring in each structure may be substituted with a halogen atom, an alkyl group, or an aryl group.

From a viewpoint of balance between heat resistance, mechanical property and processibility, particularly preferable liquid crystal polyester contains a repeating unit of: 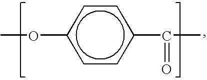
and further preferably contains the repeating unit at least 30 mol % or more of a whole. A liquid crystal polyester having any one of repeating unit combinations of the following (I) to (VI) is preferable. As the following liquid crystal polyester, liquid crystal polyesters in which an aromatic ring is substituted with a halogen group, an alkyl group, or an aryl group can be used.

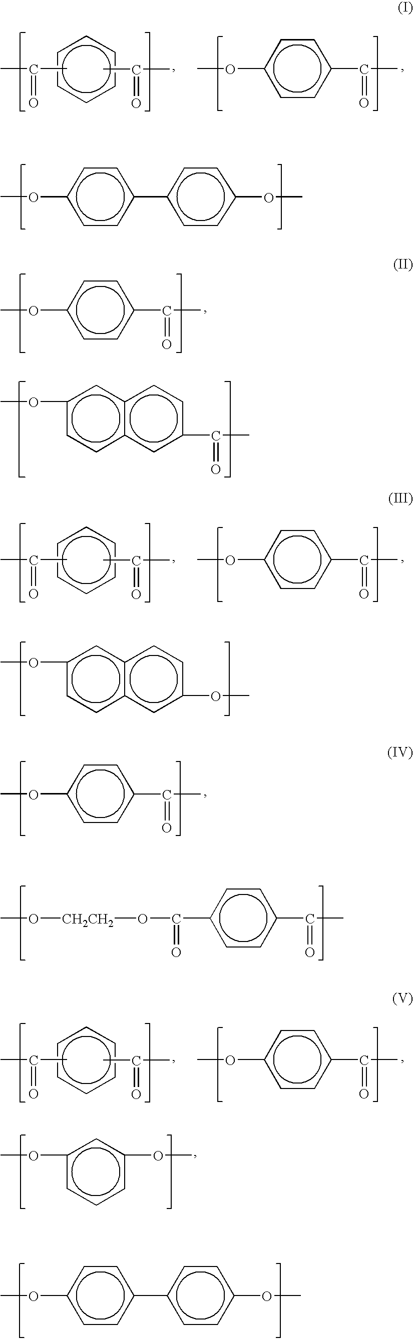

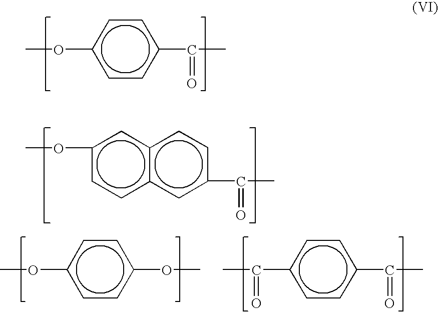

A process for preparing the liquid crystal polyesters (I) to (VI) is described, for example, in JP-B No. 47-47870, JP-B No. 63-3888, JP-B No. 63-3891, JP-B No. 56-18016, and JP-A No. 2-51523. Among them, preferable are a combination of (I) or (II) or (VI), and further preferable are a combination of (I) or (II).

In the field requiring particularly high heat resistance, a liquid crystal polyester containing 30 to 80 mol % of the following repeating unit (a′), 0 to 10 mol % of the following repeating unit (b′), 10 to 25 mol % of the following repeating unit (c′), and 10 to 35 mol % of the repeating unit (d′) is preferably used. 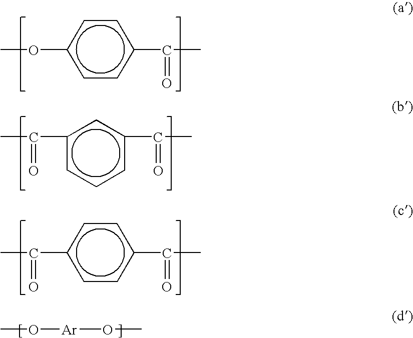
(wherein Ar is a divalent aromatic group, and the aforementioned aromatic ring of the (a′) to (d′) substituted with a halogen group, an alkyl group, or an aryl group may be used)

As the repeating unit (d′), the aforementioned diol is preferable and, in utility requiring particularly high heat resistance, wholly aromatic diol is preferable.

As a liquid crystal polyester to be used, a liquid crystal polyester of a combination of only carbon, hydrogen and oxygen is preferably used from a viewpoint of easy waste by incineration after use.

As a layer composed of a liquid crystal polymer, a liquid crystal polymer film can be used and, from a viewpoint of such the moldability that such the liquid crystal polymer film is stably used, it is further preferable to use, as the liquid crystal polymer, a liquid crystal polyester resin composition containing (A) liquid crystal polyester as a continuous phase, and (B) a copolymer having a functional group having reactivity with liquid crystal polyester as a dispersion phase.

As the component (B) used in the liquid crystal polyester resin composition, a copolymer having a functional group having reactivity with liquid crystal polyester is preferable. Examples of such the functional group having reactivity with a liquid crystal polyester include an oxazolyl group, an epoxy group and an amino group. Preferable is an epoxy group.

An epoxy group and the like may be present as a part of other functional group, and examples include a glycidyl group.

In a copolymer (B), a method of introducing a functional group having reactivity with a liquid crystal polymer such as liquid crystal polyester into the copolymer is not particularly limited, but introduction can be performed by known methods. For example, it is possible to introduce a monomer having the functional group by copolymerization at a stage of synthesizing a copolymer or it is possible to graft-copolymerize the copolymer with a monomer having the functional group.

A copolymer (B) may be a thermoplastic resin or a rubber, or a mixture or a reaction product of a thermoplastic resin and a rubber. When heat stability and flexibility of a molded article such as a film and a sheet obtained using a liquid crystal polymer resin composition are considered important, a rubber can be selected.

When a copolymer (B) is a rubber, examples of a copolymer having a functional group having reactivity with a liquid crystal polymer such as a liquid crystal polyester include a rubber having an epoxy group such as a (meth)acrylic acid ester-ethylene-(unsaturated carboxylic acid glycidyl ester and/or unsaturated glycidyl ether) copolymer rubber.

Herein, (meth)acrylic acid ester means esters obtained from acrylic acid or methacrylic aicd and alcohols. Examples of alcohols include hydroxyl group-containing compounds having a carbon number of 1 to 8. Examples of (meth)acrylic acid ester include methyl acrylate, methyl methacrylate, n-butyl acrylate, n-butyl methacrylate, tert-butyl acrylate, tert-butyl methacrylate, 2-ehtylhexyl acylate and 2-ethylhexyl methacrylate. As the (meth)acrylic acid ester, one kind thereof may be used alone or two or more kinds may be used together.

Examples of unsaturated carboxylic acid glycidyl ester and unsaturated glycidyl ether include the following general formula: 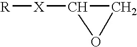
(wherein R represents a hydrocarbon group of a carbon number of 2 to 13 having an ethylenic unsaturated bond, and X represents —C(O)—, —CH₂—O— or

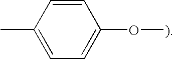

Examples of unsaturated carboxylic acid glycidyl ester include glycidyl acrylate, glycidyl methacylate, itaconic acid diglycidyl ester, butenetricarboxylic acid triglycidyl ester, and p-styrene carboxylic acid glycidyl ester.

Examples of unsaturated glycidyl ether include vinyl glycidyl ether, allyl glycidyl ether, 2-methylallylglycidyl ether, methacryl glycidyl ether, and styrene-p-glycidyl ether.

Among the aforementioned copolymer rubber, a content of a (meth)acrylic acid ester monomer unit in a copolymer is preferably in a range of 40 to 97% by weight, further preferably 45 to 70% by weight.

A content of an ethylene monomer unit is preferably in a range of 3 to 50% by weight, further preferably in a range of 10 to 49% by weight. A content of an unsaturated carboxylic acid glycidyl ether monomer unit and/or an unsaturated glycidyl ether monomer unit is preferably in a range of 0.1 to 30% by weight, more preferably in a range of 0.5 to 20% by weight.

The copolymer rubber can be prepared by a conventional method such as bulk polymerization, emulsion polymerization, and solution polymerization using a free radical initiator. A representative polymerization method is a method described in JP-B No. 48-11388 or JP-A No. 61-127709, and the rubber can be prepared in the presence of a free radical generating polymerization initiator under condition of a pressure of 500 kg/cm²(49.0 MPa) or higher, and a temperature of 40 to 300° C.

In addition to the aforementioned rubbers, an acryl rubber having a functional group having reactivity with liquid crystal polyester, or a block copolymer rubber of a vinyl aromatic hydrocarbon compound having a functional group having reactivity with liquid crystal polyester and conjugated diene compound can be also used.

Examples of a monomer of an acryl rubber referred herein include monomers represented by the general formulas (1) to (3):
CH₂═CH—C(O)—OR¹ (1)
CH₂═CH—C(O)—OR²OR³ (2)
CH₂═CR⁴—C(O)—O(R⁵(C(O)O)ₙR⁶ (3)
(wherein R¹ represents an alkyl group of a carbon number of 1 to 18 or a cyanoalkyl group of a carbon number of 1 to 18, R² is an alkylene group of a carbon number of 1 to 12, R³ represents an alkyl group of a carbon number of 1 to 12, R⁴ represents a hydrogen atom or a methyl group, R⁵ represents an alkylene group of a carbon number of 3 to 30, R⁶ represents an alkyl group of a carbon number of 1 to 20 or a derivative thereof, and n represents an integer of 1 to 20)

A constitutional component ratio of an acryl rubber having a functional group having reactivity with a liquid crystal polymer, represented by liquid crystal polyester, is usually that at least one kind monomer selected from monomers represented by the general formulas (1) to (3) is 40 to 99.9% by weight, unsaturated carboxylic acid glycidyl ester and/or unsaturated glycidyl ether is 0.1 to 30% by weight, and an unsaturated monomer copolymerizable with monomers represented by the general formulas (1) to (3) is 0 to 30% by weight.

Examples of acrylic acid alkyl ester represented by the general formula (1) include methyl acrylate, ethyl acrylate, propyl acrylate, butyl acrylate, pentyl acrylate, hexyl acylate, octyl acrylate, 2-ethylhexyl acrylate, nonyl acrylate, decyl acrylate, dodecyl acrylate, and cyanoethyl acrylate. These one or two or more kinds can be used as a main component of the acryl rubber.

In addition, examples of acrylic acid alkoxyalkyl ester represented by the general formula (2) include methoxyethyl acrylate, ethoxyethyl acrylate, butoxyethyl acrylate, and ethoxyethyl acrylate. These one or two or more kinds can be used as a main component of the acryl rubber.

Examples of the acrylic acid derivative represented by the general formula (3) include acryloyloxy-butyric methyl ester, and methacryloxy-heptanoic acid methyl ester. These one or two or more kinds can be used as a main component of the acryl rubber.

As a constitutional component of an acryl rubber, an unsaturated monomer copolymerizable with monomers represented by the general formulas (1) to (3) can be used, if necessary.

Examples of such the unsaturated monomer include styrene, α-methylstyrene, acrylonitrile, halogenated styrene, methacrylonitrile, acrylamide, methacrylamide, vinylnaphthalene, N-methylolacrylamide, vinyl acetate, vinyl chloride, vinylidene chloride, benzyl acrylate, methacrylic acid, itaconic acid, fumaric acid, and maleic acid.

A process for preparing the acryl rubber is not particularly limited, but for example, the known polymerization method described, for example, in JP-A No. 59-113010, JP-A No. 62-64809, JP-A No. 3-160008, and WO95/04764 can be used, and the acryl rubber can be prepared by emulsion polymerization, suspension polymerization, solution polymerization or bulk polymerization in the presence of a radical initiator.

In addition to the acryl rubber, examples of a block copolymer of the vinyl aromatic hydrocarbon compound having a functional group having reactivity with liquid crystal polyester and conjugated diene compound include a rubber obtained by epoxylating a block copolymer composed of (a) a sequence mainly containing a vinyl aromatic hydrocarbon compound and (b) a sequence containing mainly a conjugated diene compound, and a rubber obtained by epoxylating a hydrogenated material of the block copolymer.

Examples of the (a) vinyl aromatic hydrocarbon compound include styrene, vinyltoluene, divinylbenzene, α-methylstyrene, p-methylstyrene, and vinylnaphthalene. Inter aria, styrene is preferable.

Examples of the (b) conjugated diene compound include butadiene, isoprene, 1,3-pentadiene, and3-butyl-1,3-oxtadiene. Butadiene or isoprene is preferable.

Such the block copolymer of vinyl aromatic hydrocarbon compound-conjugated diene compound or a hydrogenated product thereof can be prepared by the known process, and the process is described, for example, in JP-B No. 40-23798, and JP-A No. 59-133203.

A rubber used as the copolymer (B) is vulcanized as necessary, and can be used as a vulcanized rubber.

Vulcanization of the copolymer rubber of the (meth) acrylic acid ester-ethylene-(unsaturated carboxylic acid glycidyl ester and/or unsaturated glycidyl ether) is attained by using a polyfunctional organic acid, a polyfunctinal amine compound, or an imidazole compound, being not limiting.

When the copolymer (B) is a thermoplastic resin other than a rubber, for example,

(a) ethylene,

(b) unsaturated carboxylic acid glycidyl ester monomer and/or unsaturated glycidyl ether monomer,

(c) ethylenic unsaturated ester compound;

Examples include epoxy group-containing ethylene copolymers obtained by reacting the above (a) and (b), or (a), (b) and (c). Inter alia, it is preferable that an ethylene unit in a copolymer is in a range of 50 to 99% by weight, and unsaturated carboxylic acid glycidyl ester monomer unit and/or an unsaturated glycidyl ether monomer unit is in a range of 0.1 to 30% by weight, and an ethylene unsaturated ester compound unit is in a range of 0 to 50% by weight. Further, among them, it is further preferable that a range of an unsaturated carboxylic acid glycidyl ester monomer unit and/or an unsaturated glycidyl ether monomer unit is 0.5 to 20% by weight.

Examples of the ethylene unsaturated ester compound (c) include carboxylic acid vinyl ester such as vinyl acetate, vinyl propionate, methyl acrylate, ethyl acrylate, butyl acrylate, methyl methacrylate, ethyl methacrylate, and butyl methacrylate and α,β-unsaturated carboxylic acid alkyl ester. Inter alia, vinyl acetate, methyl acrylate, and ethyl acrylate are preferable.

Examples of the epoxy group-containing ethylene copolymer include a copolymer of an ethylene unit and a glycidyl methacrylate unit, a copolymer of an ethylene unit, a glycidyl methacrylate unit and a methyl acrylate unit, a copolymer of an ethylene unit, a glycidyl methacrylate unit and an ethyl acrylate unit, and a copolymer of an ethylene unit, a glycidyl methacrylate unit and a vinyl acetate unit.

A melt flow rate (hereinafter, referred to as MFR in some cases, JIS K7210, 190° C., 2.16 kg load) of the epoxy group-containing ethylene copolymer is preferably 0.5 to 100 g/10 min, further preferably 2 to 50 g/10 min. A melt flow rate may be outside this range, but when a melt flow rate exceeds 100 g/10 min, this may not be preferable in mechanical property when formulated into a composition and, when a melt flow rate is less than 0.5 g/10 min, compatibility with a liquid crystal polymer, such as liquid crystal polyester, of a component (A) may not be superior, being not preferable.

In addition, regarding the epoxy group-containing ethylene copolymer, a copolymer having a flexural modulus in a range of 10 to 1300 kg/cm² (0.98 to 127.49 MPa) may be selected, but 20 to 1100 kg/cm² (1.96 to 107.87 MPa) is further preferable.

The epoxy group-containing ethylene copolymer is usually prepared by a high pressure radical polymerization method in which an unsaturated epoxy compound and ethylene are copolymerized at 100 to 300° C. under a pressure of 500 to 4000 atm in the presence or the absence of a suitable solvent and a chain transfer agent in the presence of a radical generator. Alternatively, the epoxy group-containing ethylene copolymer can be also prepared by a method of mixing a polyethylene with an unsaturated epoxy compound and a radical generator, and subjecting the mixture to melt graft copolymerization in an extruder.

As the copolymer (B), a copolymer in which 0.1 to 30% by weight of an unsaturated carboxylic acid glycidyl ester monomer unit and/or an unsaturated glycidyl ether monomer unit is contained in the copolymer, is preferably used.

It is preferable to use the copolymer (B) having a crystal melting heat amount of less than 3J/g.

A Mooney viscosity is preferably 3 to 70, more preferably 3 to 30, and particularly preferably 4 to 25.

As used herein, a Mooney viscosity refers to a value measured using a 100° C. large rotor according to JIS K6300. When the viscosity is outside the range, there is a tendency that a heat stability of the composition is reduced.

The copolymer (B) to be used is preferably a copolymer of a combination of only carbon, hydrogen and oxygen, from a viewpoint of easy waste by incineration after use.

Examples of a liquid crystal polyester resin composition used in the present invention include a resin composition comprising (A) 56.0 to 99.9% by weight, preferably 70.0 to 99.9% by weight, further preferably 80 to 98% by weight of liquid crystal polyester, and (B) 44.0 to 0.1% by weight, preferably 30.0 to 0.1% by weight, further preferably 20 to 2% by weight of a copolymer having a functional group having reactivity with a liquid crystal polyester.

A film containing (B) a copolymer having a functional group having reactivity with a liquid crystal polyester is more preferable since adherability to an aramid paper is improved.

As a process for preparing a liquid crystal polyester resin composition containing a liquid crystal polyester (A) and a copolymer (B), the conventional method can be used. Examples include a method of mixing each component in the solution state, and evaporating a solvent, or precipitating the composition in a solvent. Specifically, a method of kneading each component in the melted state can be selected. For melt kneading, a kneading apparatus such as a monoaxial or biaxial extruder, and various kneaders which are generally used can be used. In particular, a biaxial high kneading machine is preferable.

Upon melt kneading, a set temperature of a cylinder of a kneading apparatus can be selected from a range of 200 to 360° C., and it is possible to implement melt kneading in a range of 230 to 350° C.

Upon kneading, respective components may be uniformly mixed with an apparatus such as a tumbler and a Henschel mixer in advance, or if necessary, mixing is omitted, and a method of quantitatively supplying respective components to a kneading apparatus separately.

If necessary, various additives such as an organic filler, an antioxidant, a heat stabilizer, a light stabilizer, a flame-retardant, lubricant, an antistatic agent, a rust-proofing agent, a crosslinking agent, a foaming agent, a fluorescent agent, a surface smoothing agent, a surface lust improving agent, and a release improving agent such as a fluorine resin can be added to a liquid crystal polyester resin composition during a preparing step or at a processing step thereafter, and it is preferable to use additives other than a halogen or additives which do not leave an ash after combustion.

A process for preparing the aramid laminate of the present invention is a process of immersing an interior of the layer comprising an aramid paper with the liquid crystal polymer or a composition thereof, and laminating a layer comprising an aramid paper and a layer containing a liquid crystal polymer. Specifically, examples include a method of spraying or adhering a powder of a liquid crystal polymer to a surface of a layer comprising an aramid layer, followed by impregnating an interior of an aramid paper by heating to melt the powder, a method of coating a liquid crystal polymer dissolved in the solvent to an aramid paper to enter an interior of an aramid, followed by drying a solvent, and a method of overlaying a molded film containing a liquid crystal polymer (hereinafter, referred to as “liquid crystal polymer film”) on an aramid paper, and thermally fusing them, followed by impregnation into an interior of an aramid paper. From a viewpoint of processibility and workability of application and the like, a method of overlaying a liquid crystal polymer film on an aramid paper, and thermally fusing them is preferable.

Examples of the method of overlaying a liquid crystal polymer film on an aramid paper, and thermally fusing them include a method of performing thermal fusing with a thermal press and a thermal roll.

By such the thermal fusing method, voids of an aramid paper are impregnated with a liquid crystal polymer, and a surface and an interior of an aramid paper are impregnated with a liquid crystal polymer, thereby, a layer comprising an aramid paper and a layer comprising a liquid crystal polymer are laminated. As a result, since adherability between a liquid crystal polymer and an aramid paper can be further enhanced, it is preferable to perform thermal fusing with a thermal press or a thermal roll. A liquid crystal polymer may be impregnated into an entire interior of an aramid paper, or may be impregnated into a part of the interior.

A temperature range upon thermal fusing is usually from a temperature lower than a flowing temperature of a liquid crystal polymer by 30° C. to lower than 400° C. When a heating temperature is further lower than temperature lower than a flowing temperature of a liquid crystal polymer by 30° C., a liquid crystal polymer is not sufficiently melted in some cases. In addition, at a temperature of 400° C. or higher, a part of a liquid crystal polymer is thermally degraded in some cases.

A pressure when a crystal liquid polymer film and an aramid paper are thermally fused is usually set at 10 kg/cm² or higher as expressed by a planar pressure in the case of use of a thermal press. A linear pressure is usually set at 20 kg/cm or higher in the case of use of a thermal roll.

Herein, a flowing temperature (FT) refers to a temperature (° C.) at which a melt viscosity measured with a capillary-type rheometer exhibits 48,000 poise, when a resin which has been heated and melted at a temperature raising rate of 4° C./min is extruded through a nozzle of an inner diameter of 1 mm and a length of 10 mm under a load of 100 kgf/cm².

Examples of a method of molding a liquid crystal polymer film include a method of obtaining a film from a solution in which a liquid crystal polymer is dissolved in a solvent, by a casting method, a method of molding into a film by a thermal press, and a molding method using a T die or an inflation die.

Inter alia, a T die method of extruding a melt resin through a T die and winding a film, an inflation molding method of extruding a melt resin into a cylinder shape from an extruder in which a circular die is arranged, and cooling and winding a film, a thermal pressing method, and a molding method using a calendar or a roll are preferably used, and further preferable is a T die method, and a more preferable is an inflation molding method.

In inflation molding, a liquid crystal polyester composition containing the (A) liquid crystal polyester and the (B) copolymer having a functional group having reactivity with liquid crystal polyester is preferably used. More preferably, a blowing ratio (a stretching ratio in a direction orthogonal with a resin flowing direction (TD)) is not less than 1.5 and less than 10, and a drawing down ratio (a stretching ratio in a resin flowing direction (MD)) is 1.5 to 50.

When a setting condition at inflation molding is outside the aforementioned range, it may become difficult to obtain a film having a uniform thickness, no crease and a high strength in some cases. That is, when a blowing ratio is less than 1.5, a strength in a TD direction of the resulting film is not sufficient in some cases, being not preferable. In addition, a blowing ratio is not less than 10, a film having a stable thickness may not be obtained in some cases, being not preferable. In addition, when a drawing ratio is less than 1.5, a strength in a MD direction of the resulting film may not be sufficient in some cases, being not preferable. In addition, when a drawing down ratio is not less than 50, a film having a stable thickness may not be obtained in some cases, being not preferable.

A thickness of a liquid crystal polymer film is not particularly limited, is appropriately determined by a thickness of an aramid paper, and a finally required thickness of an aramide laminate, and is usually in a range of not less than 0.5 μm and not more than 2 mm, preferably not less than 5 μn and not more than 500 μm.

A normally used heat resistant temperature of a liquid crystal polymer to be used is usually 140° C. or higher, preferably 160° C. or higher. Herein, a normally used heat resistant temperature indicates a temperature at which a time necessary for reduction in a MD direction tensile breakage strength by ½ is 40,000 hours. Further, a solder heat resistance temperature of the liquid crystal polymer is usually 250° C. or higher, preferably 280° C. or higher. Herein, a solder heat resistant temperature indicates an upper limit temperature at which a film is immersed in a heated solder bath for 10 seconds, and no foaming due to shrinkage or thermal degradation is perceived.

A water steam permeability of a liquid crystal polymer is usually 1.0 g/m²·24 hr or lower, preferably 0.8 g/m²·24 hr or lower. When a water steam permeability is great, there is a possibility that water absorption of an araimd laminate obtained after lamination of an aramid paper may become great, being not preferable. A water absorption rate is preferably less than 0.2%, further preferably 0.1%. When a water absorption rate is great, upon use of an aramid laminate as a circuit board, deteriorated application to a copper foil at procession may occur in some cases, being not preferable.

A surface free energy of a liquid crystal polymer is preferably 35 dyne/cm or more. When the energy is less than that value, unevenness of application to an aramid paper may occur and, when the resulting aramid laminate is adhered to a coated board, a resin, a metal, or a timber, there may be a possibility that a laminate is peeled during long term use, being not preferable. When a surface free energy of a liquid crystal polymer such as a liquid crystal polymer film is less than 35 dyne/cm, surface treatment such as corona treatment may be performed.

A metal layer may be further laminated on an aramid laminate obtained above.

A metal used in a metal layer may be a conductor metal such as gold, silver, copper and iron and, usually, copper is used. Examples of a method of forming a metal layer include a method of forming a layer using a metal foil, and a method of forming a layer on a layer comprising an aramid paper or a layer comprising a liquid crystal polymer by metal plating or metal deposition. As a metal foil, a rolled foil or an electrolytic foil is usually used. Metal plating may be electrolytic plating or non-electrolytic plating. Further, another layer may be laminated on a metal layer, and a wiring circuit pattern may be formed in advance on a metal layer by performing etching treatment on a metal foil. When an aramid laminate is “a laminate containing each at least one layer of a layer comprising an aramid paper and a layer comprising a liquid crystal polymer”, examples of such the aramid laminate include a three-layered aramid laminate containing each layer in an order of (i) to (iii) such as (i) a layer comprising a liquid crystal polymer, (ii) a layer comprising an aramid paper and (iii) a liquid crystal polymer. The aramid laminate is not limited to an example of the aforementioned three-layered aramid laminate, and a laminating order of each layer, and a laminating number can be arbitrarily set.

When an aramid laminate is “a laminate containing each at least one layer of a layer comprising an aramid layer, a layer comprising a liquid crystal polymer and a metal layer”, examples of such the aramid laminate include a four-layered aramid laminate containing each layer in an order of (i) to (iv) such as (i) a metal layer, (ii) a layer comprising a liquid crystal polymer, (iii) a layer comprising an aramid paper and (iv) a layer comprising a liquid crystal polymer, and a five-layered aramid laminate containing each layer in an order of (i) to (v) such as (i) a metal layer, (ii) a layer comprising a liquid crystal polymer, (iii) a layer comprising an aramid paper, (iv) a layer comprising a liquid crystal layer and (v) a metal layer. These aramid laminates containing a metal layer are not limited to an example of the aforementioned four to five-layered aramid-laminates, and a lamination order of each layer and a lamination number can be arbitrarily set, but an aramid laminate has preferably a construct containing a laminate structure in which a layer comprising an aramid paper is held between a layer comprising a liquid crystal polymer and a layer comprising a liquid crystal polymer, from a viewpoint of reduction in water absorption. An aramid laminate containing a metal layer on which a wiring circuit pattern is formed can be suitably used as a circuit substrate.

### EXAMPLE 1

The present invention will be explained in detail by way of Examples, but the present invention is not limited to only Examples. Each physical property is measured by following method.

[Method of Measuring Physical Property]

Flowing temperature (FT): this is an index for showing melt flowability, and was measured with a capillary-type rheometer (Elevation-type flow tester CFT500 type manufactured by Shimadzu Corporation), and a flowing temperature was expressed as a temperature (° C.) at which a melt viscosity shows 48,000 poise when a sample resin (about 2 g) which has been heated and melted at a temperature raising rate of 4° C./min is extruded through a nozzle of an internal diameter 1 mm and a length 10 mm under a load of 100 kg/cm².

Optical anisotropy: optical anisotropy of a sample resin in the melt state was confirmed by raising a temperature of a sample resin powder of a particle diameter of 250 μm or smaller placed on a heating stage at 25° C./min under polarization, and observing with naked eyes or recording an amount of transmitted light with a XY recorder.

Method of measuring heat resistance of film:

<Normally Used Heat Resistant Temperature>

A film was placed in a hot air oven retained at 50° C., 100° C., 150° C., 200° C., or 250° C., the film was taken out every 500 hours from 0 hour to 2500 hours, allowed to stand in a constant temperature constant humidity chamber (23° C., 55% RH) for one day, and a tensile strength in a MD direction was measured to obtain a time dependent curve of a strength. Therefrom, a time at which a strength becomes a half of strength at 0 hour was obtained every temperature, the resulting time (reduction by half time) was plotted against a temperature to obtain a curve, and a temperature in the case where reduction by half time was 40,000 hours was adopted as a normally used heat resistance temperature. A tensile strength of a film was according to JIS C2318.

<Solder Heat Resistance Temperature>

A solder heat resistance temperature was assessed by an upper limit temperature at which a film was immersed in a heated solder bath for 10 seconds, and no foaming due to shrinkage and thermal degradation was perceived.

Method of measuring water steam permeability and water absorption rate of film:

<Water Steam Permeability>

A water steam permeability was measured at a temperature of 40° C. and a relative humidity of 90% according to JIS Z0208 (cup method). A unit is g/m²·24 hr.

A water steam permeability is not converted by a film thickness.

<Moisture Absorption Rate>

Letting a mass of a substrate film after heating and drying at 120° C. for 2 hours in a hot air oven to be A, and a mass after 24 hours from allowing to stand of the film in a chamber retained at a constant temperature and a constant humidity, which was adjusted to 20° C. and 70% RH to be B, a moisture absorption rate was measured by the following equation.
Moisture absorption rate (%)={(B−A)/B}=100
<Coefficient of Thermal Expansion>

A Coefficient of thermal expansion was measured using a thermal analysis apparatus TMA120 manufactured by Seiko Electronics, and was calculated by the following equation, according to ASTM D696.
α1=ΔL/L₀·ΔT
wherein α1: Coefficient of thermal expansion(/° C.)

ΔL: change length of test piece

L₀: test piece length before test

ΔT: temperature difference (° C.)

Assessment of surface free energy of support substrate film:

According to JIS K6768, a standard solution was coated, followed by determination:

### REFERENCE EXAMPLE

(1) Liquid crystal polymer exhibiting optical anisotropy at melting

(1-1) (A) Liquid crystal polyester constituting liquid crystal polymer exhibiting optical anisotropy at melting.

A polymerization vessel having a comb-type stirring wing was charged with 8.3 kg (60 mol) of p-acetoxybenzoic acid, 2,49 kg (15 mol) of terephthalic acid, 0.83 kg (5 mol) of isopthalic acid and 5.45 kg (20.2 mol) of 4,4′-diacetoxydiphenyl, a temperature was raised while stirring under the nitrogen gas atmosphere, and polymerization was performed at 330° C. for 1 hour. Polymerization was performed under strong stirring, while an acetic acid gas produced as a by product during that time was liquefied with a cooling tube, recovered and removed. Thereafter, the system was gradually cooled, and a polymer obtained at 200° C. was taken out from the system. This resulting polymer was ground to a particle of 2.5 mm or smaller with a hammer mill manufactured by Hosokawa Micron Corporation. This was further treated at 280° C. for 3 hours under the nitrogen gas atmosphere in a rotary kiln, to obtain a particulate wholly aromatic polyester consisting of the following repeating structural unit having a flowing initiating temperature of 327° C.

Herein, the following initiating temperature refers to a temperature (° C.) at which a melt viscosity shows 48000 poise when a resin which has been heated and melted at a temperature raising rate of 4° C./min is extruded through a nozzle of an internal diameter of 1 mm and a length of 10 mm under a load of 100 kgf/cm², using a Shimadzu flow tester CFT-500 type manufactured by Shimadzu Corporation.

Hereinafter, the liquid crystal polyester is abbreviated as A-1. This polymer showed optical anisotropy at 340° C. or higher under pressure. A repeating structural unit and its constitutional ratio of liquid crystal polyester A-1 are as follows. 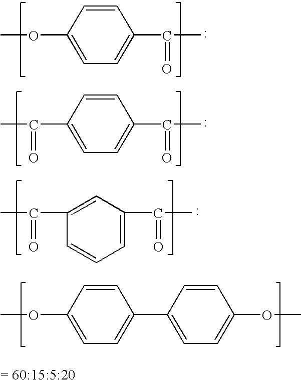
(1-2) (B) Copolymer having reactivity with liquid crystal polyester constituting liquid crystal polymer exhibiting optical anisotropy at melting

According to the method described in Example 5 of JP-A No. 61-127709, a rubber of methyl acrylate/ethylene/glycidyl methacrylate=59.0/38.7/2.3 (ratio by weight) and a Mooney viscosity=15 was obtained. Hereinafter, the rubber is abbreviated as B-1 in some cases.

Herein, a Mooney viscosity is a value measured using a 100° C. large rotor according to JIS K6300. In addition, a melting heat was measured for 10 mg of a sample at a scanning temperature of 10° C./min using DSC-50 manufactured by Shimadzu having a sensitivity of 0.01 J/g. A melting point could not be detected, and a melting heat could not be measured.

(2) Aramid Paper

A commercially available P-aramid pulp (Twaron 1094 manufactured by Akzo Nobel K. K., specific surface area 4.55 m²/g, filtered water degree 683 ml) as a single material was subjected to wet paper making at a weight of 37 g/m² by a conventional method, and passed through a calendar roll set at 280° C. at a linear pressure of 25 kg/cm to obtain an aramid paper. A thickness of this aramid paper was 55 μm. A torn length was 0.57 km. A moisture absorption rate was 4.5%. In addition, a Coefficient of thermal expansion measured at 50° C. to 150° C. by a TMA method was 3×10⁻⁶/° C. in both of a MD direction and a TD direction. The aramid paper is called P-1 in some cases.

### EXAMPLE 1

At a blending ratio of 82 parts by weight of A-1 and 18 parts by weight of B-1, melting and kneading was performed at a cylinder set temperature of 350° C. under a screw rotation number of 450 rpm using a TEX-30 type biaxial extruder manufactured by The Japan Steel Works, Ltd. to obtain a composition in which A-1 is a continuous phase, and B-1 is a dispersion phase. This composition pellet exhibited optical anisotropy at 340° C. or higher under pressure, and a flowing temperature was 328° C. The resulting composition is called C-1 in some cases.

C-1 was melted and extruded at a cylinder set temperature of 350° C. under a screw rotation number of 60 rpm using a 60 mmφ monoaxial extruder equipped with a cylinder die, a melted resin was extruded upwardly from a cylindrical die of a diameter 50 mm, a lip interval 1.0 mm and a die set temperature 348° C., the dried air was pressed in a hollow part of the resulting cylindrical film, this was inflated, cooled, and passed through a nip roll to obtain a film. A blowing ratio was 2.5, a drawing down ratio was 16, and an actually measured average thickness of a film was 25 μm. A water stream permeability of the film was 0.4 (g/m²·24 hr), and a water absorption rate was better as 0.05%. In addition, a tensile elastic modulus in a MD direction was 3400 kgf/mm, and a breakage elongation was 2% or smaller.

A normally used heat resistant temperature was 170° C. A solder heat resistance temperature was 285° C. In addition, a surface free energy of the film was 40 dyne/cm.

Further, a Coefficient of thermal expansion measured at 50° C. to 150° C. by a TMA method was −20×10⁻⁶/° C. in a MD direction, and 30×10⁻⁶/° C. in a TD direction, and anisotropy was recognized. The film is called F-1 in some cases.

P-1 and F-1 were overlaid in an order of (I) F-1, (II) P-1 and (III) F-1, and this was passed through a calendar roll set at 325° C. (a temperature of a flowing temperature of C-1 minus 3° C.) at a linear pressure of 25 kg/cm to obtain a laminate L-1 having an average actually measured thickness of 77 μm. A water absorption rate of L-1 was better as 0.8%. When the laminate was immersed in a solder bath regulated at 280° C. for 10 seconds, deformation was not recognized, and appearance was also better.

A Coefficient of thermal expansion measured at 50° C. to 150° C. by a TMA method was 3×10⁻⁶/° C. in both of a MD direction and a TD direction, and anisotropy was not recognized.

### EXAMPLE 2

P-1 and F-1 obtained in Example 1, and electrolytic copper foil M-1 of a thickness of 18 μm were overlaid in an order of (i) to (v) such as (i) M-1, (ii) F-1, (iii) P-1, (iv) F-1 and (v) M-1, and passed through a calendar roll set at 325° C. (a temperature of a flowing temperature of C-1 minus 3° C.) at a linear pressure of 50 kg/cm to obtain a laminate L-2 having an average actual measured thickness of 112 μm. A simple circuit having a copper foil residual area rate of 20% was made on a copper foil on both surfaces of L-2 by conventional etching treatment to obtain a double-sided circuit substrate B-1. A water absorption rate of B-1 was better as 0.8%. In addition, the substrate was immersed in a solder bath adjusted at 280° C. for 10 seconds and deformation was not recognized, and appearance was also better. In addition, after immersion in a solder bath, breakage of a circuit is not recognized.

### COMPARATIVE EXAMPLE 1

According to the same manner as that of Example 1 except that a commercially available PET film having a thickness of 25 μm (Toyobo Espet) was used in place of F-1, a temperature of calendar roll was 250° C., and a linear pressure was 80 kg/cm, a laminate R-1 having an average actually measured thickness of 78 μm was obtained. A water absorption rate of R-1 was 1.6%, therefore, this can not be said to be better. In addition, when the laminate was immersed in a solder bath adjusted at 280° C. for 10 seconds, it was greatly deformed.

### COMPARATIVE EXAMPLE 2

According to the same manner as that of Example 2 except that a commercially available PET film having a thickness of 25 μm (Toyobo Espet) was used in place of F-1, a temperature of a calendar roll was 250° C., and a linear pressure was 100kg/cm, a laminate R-2 having an average actually measured thickness of 116 μm was obtained. A simple circuit having a copper foil residual area rate of 20% was made on a copper foil of both surfaces of R-2 by conventional etching treatment to obtain a double-sided circuit substrate R-3. A water absorption rate of R-3 was 1.6%.

In addition, when the laminate was immersed in a solder bath adjusted at 280° C. for 10 seconds, it was greatly deformed, and breaking of a wire of a part of a circuit was recognized.

According to the present invention, an aramid laminate which is excellent in solder heat resistance and low hygroscopicity and has little anisotropy can be obtained.

1. A process for preparing an aramid laminate, which comprises impregnating a surface and an interior of an aramid paper with a liquid crystal polymer, and laminating a layer comprising an araimd paper and a layer comprising a liquid crystal polymer.

2. The process for preparing an aramid laminate according to claim 1, wherein the liquid crystal polymer is a liquid crystal polyester resin composition in which (A) liquid crystal polyester is a continuous phase and (B) a copolymer having a functional group having reactivity with liquid crystal polyester is a dispersion phase.

3. The process for preparing an aramid laminate according to claim 2, wherein the liquid crystal polyester resin composition is a composition comprising 56.0 to 99.9% by weight of (A) liquid crystal polyester, and 44.0 to 0.1% by weight of (B) a copolymer having a functional group having reactivity with liquid crystal polyester.

4. The process for preparing an aramid laminate according to claim 1, wherein a layer comprising an aramid paper and a layer comprising a liquid crystal polymer are thermally fused in a temperature range of a temperature lower than a flowing temperature of a liquid crystal polymer by 30° C. to lower than 400° C.

5. The process for preparing an aramid laminate according to claim 4, wherein thermal fusing is performed at a pressure of a planar pressure of 10 kg/cm² or higher or a linear pressure of 20 kg/cm or higher.

6. The process for preparing an aramid laminate according to claim 1 or 2, wherein an aramid paper and a liquid crystal polymer-film are thermally fused.

7. A circuit substrate characterized by comprising an aramid laminate according to claim 1.
